(19) United States
(12) Patent Application Publication
(10) Pub. No.: US 2007/0108708 A1
(43) Pub. Date: May 17, 2007

(54) Pack-N-pull

(76) Inventor: Linda Kay Scott-Greavu, Coopersville, MI (US)

Correspondence Address: Linda Kay Scott-Greavu, 15784 40th Avenue, Coopersville, MI, 49409, US

(21) Appl. No.: 11/518,619

(22) Filed: Sep. 11, 2006

Related U.S. Application Data
(60) Provisional application No. 60/729,386, filed on Oct. 24, 2005.

(51) Int. Cl. B60N 2/427

(52) U.S. Cl. 280/29

(57) ABSTRACT

Top enclosure apparatus 4 encompasses multiple storage apparatus 5 bellow is support apparatus 3 which is above brace apparatus 2 located in base apparatus 2 is the brace apparatus 1.

### CROSS-REFERENCE TO RELATED APPLICATIONS

This application relates to and claims priority from U.S. Provisional Patent Application Ser. No. 60/729/386 filed on Oct. 24, 2005, specifications which are incorporated herein by reference.

### FEDERALLY SPONSORED RESEARCH

Not Applicable

### Sequence Listing or Program

Not Applicable

### BACKGROUND OF THE INVENTION

1. Field of Invention

This invention relates to a universal storage with multiple facets for the camping industry which will create more space for camping items in the vehicle which is used to transport camping items as well as families to their finial destination.

2. Background of Invention

In the past people would load all their camping gear which would include but not limited to flat fry pans and kettles, eating, eating utensils, food, tents, rain gear, chairs and various other things needed to survive away from the normal home in a camping setting. A typical camper will load up his gear which would include many pieces of cooking gear, eating utensils, clothes, towels and firewood just to mention a few. The problem arises when campers have limited space and to transport all of the various pieces of camping gear. Not only is the space restraints an issue but the time factor does come into play. To relocate camping gear from house or shed or storage does take time.

(a) The problem of time restraints when locating and relocating all the camp gear needed to live while away from a regular house.

(b) The problem of space restraints

### Background of Invention—Objects and Advantages

Accordingly, beside the objects and advantages of the current camp gear transportation method described in my above patent, several objects and advantages of the present invention are:

(a) With my new means of storage and transport time restraints will greatly decrease, there will be no need to unload and load camp gear.

(b) With my new means of storage and transport space restraints will greatly decrease because you will not have to take up valuable room in the transport vehicle.

Further objects and advantages are to provide a way of reducing time restrains, space restraints as well as creating a product which encompasses multiple use. To add, with this new means of storage and transport the process of living outside of a home will be much easier. Still further objects and advantages will become abundantly clear with the description and drawings.

### SUMMARY

In accordance with the present invention the “Pack-N-Pull” comprises of many compartments of different sizes with openings as well as doors and pull out or fold out table with elevating device which fits and locks down on a utility trailer.

### DRAWINGS—FIGURES

FIG. 1 depicts side view of the Pack-N-Pull. FIG. 1 (1) depicts the Brace apparatus. FIG. 1 (2) depicts the base apparatus. FIG. 1 (3) depicts the support apparatus. FIG. 1 (4) depicts the top enclosure apparatus. FIG. 1 (5) depicts the multiple storage compartment storage apparatus.

FIG. 2 depicts a rear view of the Pack-N-Pull. FIG. 2 (3) depicts the support apparatus. FIG. 2 (4) depicts the top enclosure apparatus. FIG. 2 (5) depicts the multiple storage apparatus.

FIG. 3 depicts the top view of the Pack-N-Pull

### DRAWINGS—REFERENCE NUMERALS

1 Brace apparatus 3 Support apparatus

2 Base apparatus 4 Top enclosure apparatus

5 Multiple storage compartment apparatus

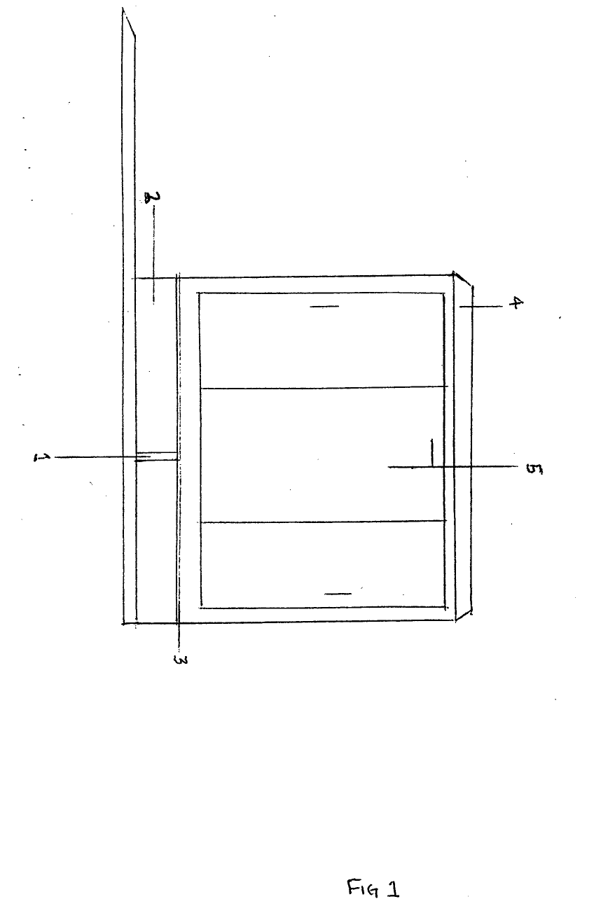

### DETAILED DESCRIPTION—FIGS 1,2 AND 3 PERFERRED EMBODIMENTS

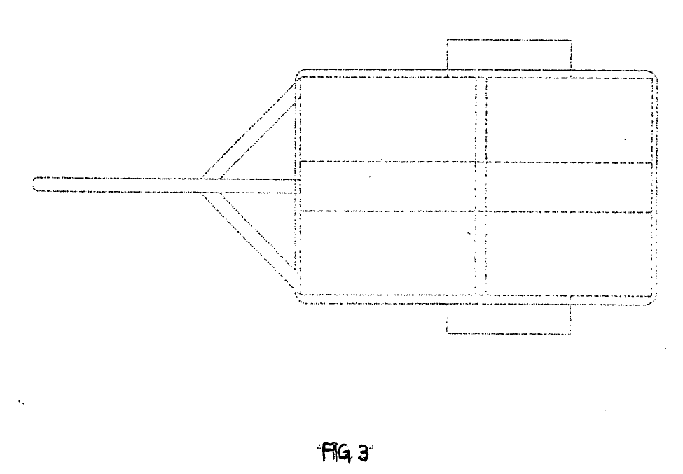

A preferred embodiment of the present invention is illustrated in FIG. 1 side view, FIG. 3 top view. The embodiment has base apparatus FIG. 1 (2) encompassing the brace apparatus FIG. 1 (1). Placeed above the base apparatus FIG. 1 (2) and brace apparatus FIG. 1 (1) the support apparatus FIG. 1 (3) is located above the base apparatus FIG. 1 (2), brace apparatus FIG. 1(1) and the support apparatus FIG. 1 (3) is the top enclosure apparatus FIG. 1 (4). Directly bellow the top enclosure apparatus FIG. 1(4) are many different sizes of walls and shelves comprising the multiple storage compartment FIG. 1 (5).

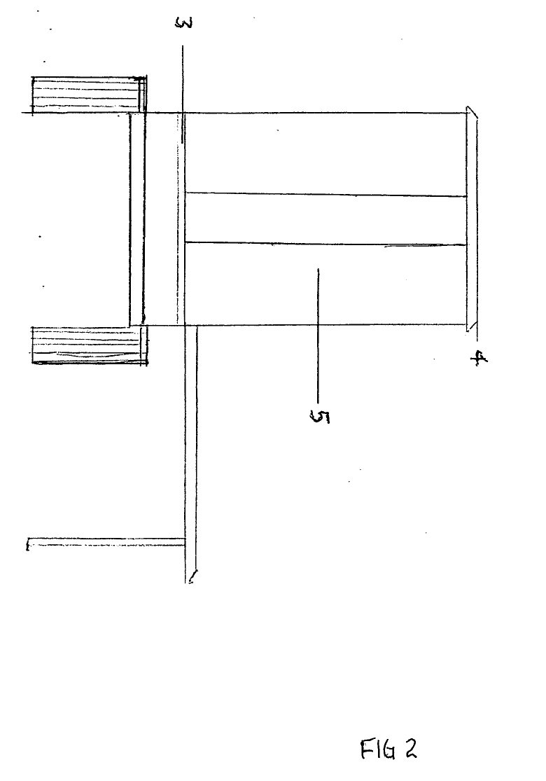

A preferred embodiment of the present invention is illustrated in FIG. 2 rear view. The embodiment has Support apparatus FIG. 2 (3) located directly beneath the multiple storage compartment apparatus FIG. 2 (5). Located above FIG. 2 (3) and FIG. 2 (5) is the top enclosure apparatus FIG. 2 (4).

A preferred embodiment of the present invention is illustrated in FIG. 3.

Operations—FIG. 1, 2 and 3

In the manner of using the Pack-N-Pull the brace apparatus 1(1), base apparatus 1 (2) support apparatus 1(3), top enclosure apparatus 1(4), 2 (4) and multiple storage compartment FIG. 1(5), 2(5) will be affixed to a utility trailer of undetermined size.

From the description above, a number of advantages of my Pack-N-Pull will become Evident.

(a) Less space will be needed in the vehicle while traveling to final destination.

(b) Less time will be needed in loading camp gear prior to camping.

(c) Less time will be needed for loading after camping.

(d) Less time will be needed for unloading after camping.

(e) Less time will be needed for unloading at camp site

(f) Promote a more tidy camp site.

(g) Save the camper money by creating a versatile multi unit.

(h) Less space will be needed while storing camping gear in the off season.

Conclusion, Ramifications and Scope

Accordingly the reader will see the Pack-N-Pull will allow for less space needed to stow camp gear. The reader will also conclude with Pack-N-Pull less time will be need for loading and unloading gear. Furthermore the reader will conclude with Pack-N-Pull the universalities will save the consumer money by way of having two trailers in one.

Thus the scope of the invention should be decided by the appended claims and their legal equivalents, rather then by examples given.

We claim:

1. A multi purpose trailer attachment with numerous compartments and fold out flat surface
(i) Brace apparatus
(ii) Base apparatus
(iii) Support apparatus
(iv) Top enclosure apparatus
(v) Multiple storage compartment apparatus

2. A multi purpose trailer with numerous compartments and fold out flat surface
(i) Brace apparatus
(ii) Base apparatus
(iii) Support apparatus
(iv) Top enclosure apparatus
(v) Multiple storage compartment apparatus
